(19) United States
(12) Patent Application Publication
(10) Pub. No.: US 2005/0005500 A1
(43) Pub. Date: Jan. 13, 2005

(54) Fishing rod rest

(76) Inventor: Terry M. Howley, Bay City, MI (US)

Correspondence Address: JOHN MCCULLOCH, 5291 COLONY DRIVE NORTH, 1ST FLOOR, SAGINAW, MI, 48603, US

(21) Appl. No.: 10/615,762

(22) Filed: Jul. 9, 2003

(51) Int. Cl. A01K 97/10

(52) U.S. Cl. 43/21.2

(57) ABSTRACT

A rest for maintaining an elongate article such as a fishing rod in a generally upright position has an upwardly inclined, notched extension in which the article removably may be accommodated when one end of the article is supported at a level below that of the extension. The rest has a concavo-convex body which is capable of partially embracing a cylindrical support rail and includes flexible tie members which may be used to clamp the body to such rail. The body also is capable of being coupled to a pair of generally parallel, confronting, spaced apart clamp members which are movable toward and away from one another so as to clamp the body in upstanding relation to a boat gunwale. A multiple part extensible and retractable arm may be coupled to one of the clamp members and is provided with a socket for the accommodation of the lower or butt end of the article. A releasable latch maintains the extensible and retractable parts of the arm in any selected one of a number of adjusted positions.

This invention relates to a rest for a fishing rod or other elongate article. The rest enables the rod to be maintained in an operative position independently of the fisherman, but permits the rod immediately to be freed from the rest when a fish is hooked.

### BACKGROUND OF THE INVENTION

When a person fishes from a boat having either a cylindrical rail or a gunwale it is conventional for the person to attach a baited hook or lure to the free end of a fishing line and lower the baited hook or lure into the water. In many cases the person simply holds the rod in one or both of his hands while fishing. On occasion, however, it is necessary to stow the rod so that both of the person's hands can be used for other purposes. In such cases it is customary to rest the butt end of the fishing rod on the boat deck or on a shelf which occupies a position at a level between the rail or gunwale and the deck. If the surface of the water is choppy the boat may rock an amount sufficient to cause the rod to slide and fall to the deck or assume an unintended position. This can be an annoyance to the user of the rod, as well as to any companions who may be sharing the boat.

A principal object of the invention is to provide a rest or support for use by a fisherman which may be mounted on some part of the boat in such manner as to support and retain a fishing rod in a position in which it is secure against inadvertent movement and still make it possible for the fisherman to remove the rod from the rest instantaneously and manipulate the rod as desired.

### SUMMARY OF THE INVENTION

A fishing rod rest or support constructed in accordance with the invention is adapted for removable attachment to a cylindrical rail of a boat or to the gunwale of the boat and be clamped thereto in such manner as to enable retention of a fishing rod in a selected position without requiring any modification of any part of the boat. In one embodiment the rest may partially embrace a cylindrical rail and be clamped thereto by disposable ties. Such rest has an upstanding projection provided with a notch in which a portion of the fishing rod removably may be accommodated.

In a second embodiment of the invention the rest body referred to above is coupled to a pair of substantially parallel, spaced apart clamp members between which some part, such as the gunwale, of a boat may be accommodated. A force applying means may be actuated to move the clamp members toward one another and clamp the boat part therebetween. In this embodiment the same body member which was referred to earlier is used, as is the notched extension.

In another embodiment of the invention a support arm may be coupled to one of the clamp members of the second embodiment by the clamping force applying means so as to extend downwardly from the rod rest when the latter is clamped to the gunwale. That end of the arm which is remote from the rod rest preferably has a socket for the removable accommodation of the butt end of the rod. This embodiment is used in those instances in which the distance from the gunwale to the deck is so great as to make it undesirable for the butt end of the rod to rest directly on the deck.

In a further embodiment of the invention the rod supporting arm may be adjustable lengthwise so as to enable a rod to be supported at any selected one of a number of different levels. The arm is composed of movable sections which may be maintained in a selected position of adjustment by latch means.

### THE DRAWINGS

Several embodiments of the invention are illustrated in the accompanying drawings wherein:

FIG. 1 is an isometric view of one fishing rod rest assembled with a cylindrical rail forming part of a boat;

FIG. 2 is a transverse sectional view of the apparatus shown in FIG. 1;

FIG. 3 is an isometric view of the rest shown in FIGS. 1 and 2 coupled to a pair of clamp members between which the gunwale of a boat is clamped, a fishing rod being shown in chain lines;

FIG. 4 is an exploded, isometric view of the embodiment shown in FIG. 3;

FIG. 5 is an end elevational view of the rest shown in FIG. 4 illustrating two different positions of one of the clamp members in the assembly of the rest;

FIG. 6 is an isometric view of the rest shown in FIGS. 3-5 and including an extensible and retractable rod-support arm;

FIG. 7 is a sectional view on an enlarged scale and taken on the line 7-7 of FIG. 6; and

FIG. 8 is an sectional view taken on the line 8-8 of FIG. 6.

### DETAILED DESCRIPTION

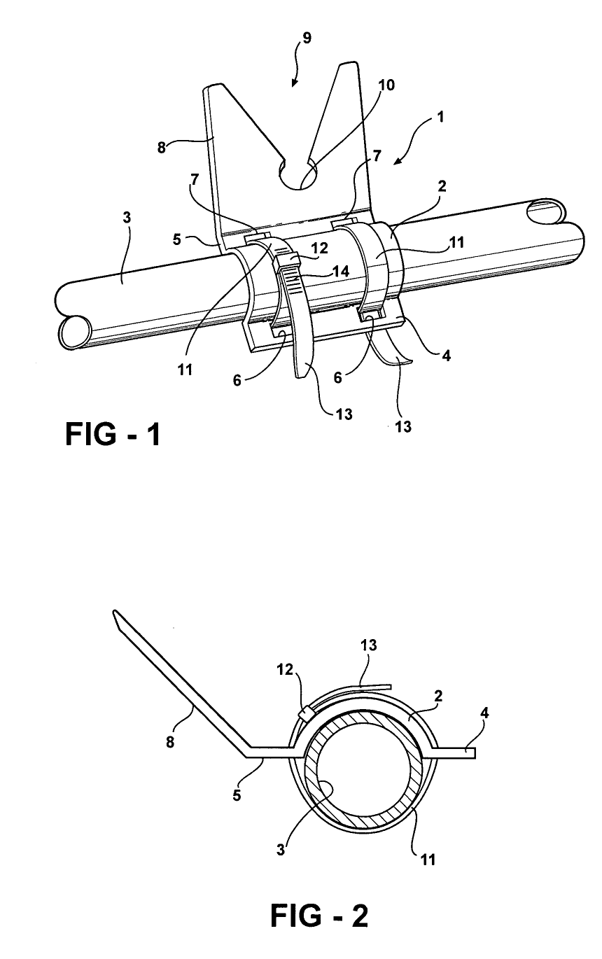

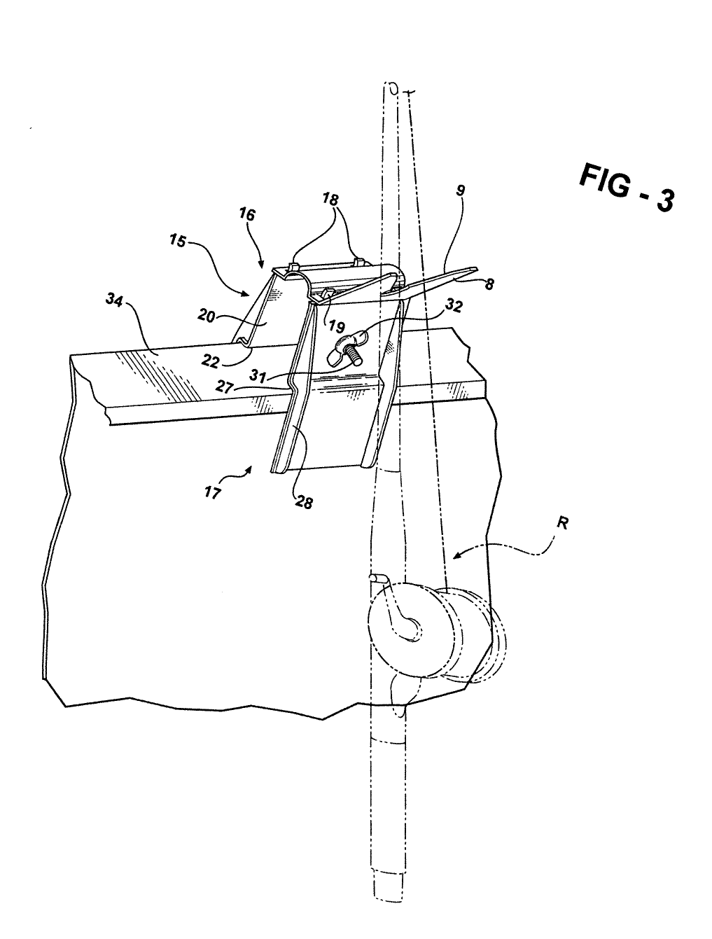

The embodiment disclosed in FIGS. 1 and 2 comprises a body 1 formed of suitable material, such as nylon, having a concavo-convex base 2 which preferably, but not necessarily, is formed on a radius corresponding substantially to that of a cylindrical support or rail 3 forming part of a boat (not shown). The arcuate base terminates at its opposite ends in flanges 4 and 5, respectively. The flange 4 has a pair of spaced slots 6 and the flange 5 has a similar pair of spaced slots 7. The flange 5 is joined integrally to an extension 8 having a V-shaped notch 9 extending obliquely upward from the free edge of the extension and terminating at its free end in a circular recess 10.

To assemble the body 1 with the rail 3 the arcuate base 2 is placed in overlying relation to the rail and flexible, plastic clamp or tie members 11 of known kind are threaded through the paired slots 6 and 7. Each tie member has at one end thereof a loop 12 through which the free end 13 of the tie member may be extended. Each loop has an inwardly projecting rib (not shown) which is adapted to engage in any one of a number of grooves 14 formed in the tie member. Following the threading of the tie members through the paired slots 6 and 7 and through the loops 12 the tie members will embrace the rail 3 in overlying relation to the arcuate base 2 and clamp the latter snugly against the rail.

The rest 1 should be so oriented on the rail 3 that the extension 8 extends obliquely upwardly in a direction inwardly of the boat. In this position of the rest a fishing rod (not shown) may have its butt end placed on the deck, or on a shelf or other surface between the deck and the rail, with an intermediate portion of the rod accommodated in the notch 9. In this position the rod will be restrained against inadvertent movement longitudinally of the rail. Depending on the thickness of the rod it may be snapped into the recess 10 so as to provide a more secure support for the rod. In any event, the rod easily may be withdrawn from the rest and manipulated by the fisherman as desired.

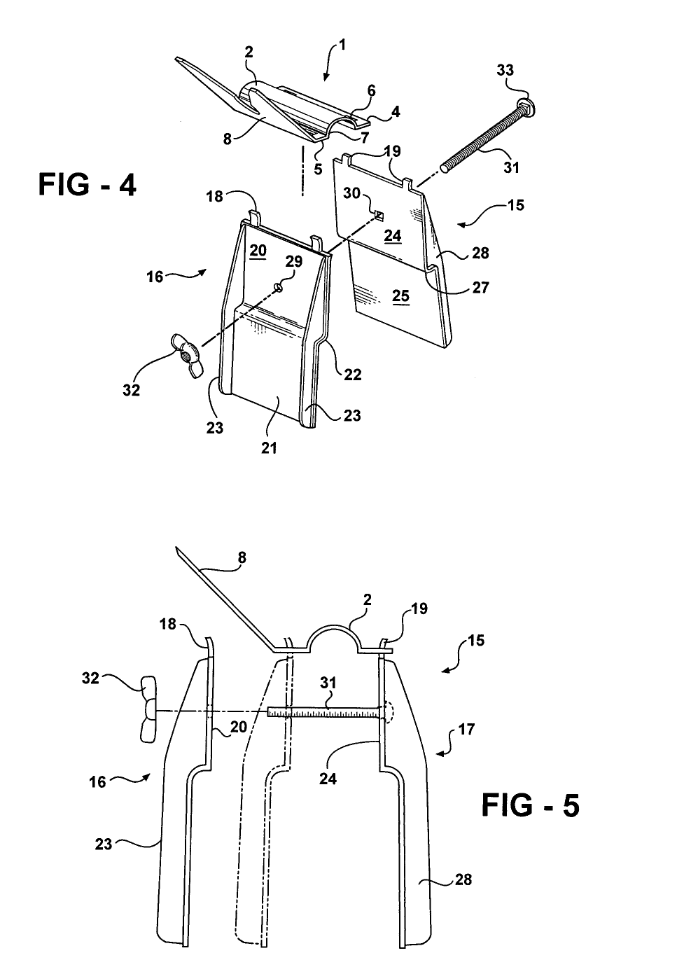

The embodiment of the invention shown in FIGS. 3-6 includes the body 1, the arcuate base 2, the flanges 4 and 5, and the extension 8. The flanges have the paired slots 6 and 7. In lieu of the tie members 11, however, this embodiment includes a clamp 15 comprising a pair of corresponding leg members 16 and 17 which confront one another but are spaced apart. The members 16 and 17 are bridged by and coupled to the base 2 by anchor lugs 18 and 19 at the upper edges of the members 16 and 17 and are of such size as to pass through the slots 6 and 7. The clamp member 16 is channel shaped and has an upper portion 20 and a lower portion 21 which are angularly offset from one another by a shoulder 22. The clamp member 16 also has side rails 23 at its opposite sides so that the clamp member is substantially channel shaped. The clamp member 17 has upper and lower sections 24 and 25, respectively, which are offset from one another so as to form a shoulder 27 therebetween. The member 17 has side rails 28 like the side rails 23.

The portion 20 of the clamp member 16 has an opening 29 therein and the portion 24 of the clamp member 17 has an opening 30 therein through which a threaded, adjustable clamp screw 31 may extend. A correspondingly threaded wingnut 32 is adapted to receive the screw 31 at one end of the latter. The opposite end of the screw has a head 33.

To condition the embodiment shown in FIGS. 3-5 for use, the mounting lugs 18 and 19 are thrust through the paired slots 6 and 7 of the body member 1. Preferably, the lugs 18 and 19 are slightly curved or hooked for the purpose of assisting in retaining the lugs in the respective openings. Following assembly of the parts 1, 15, and 16 the clamp screw 31 is extended through the openings 29 and 30 and the wingnut 32 threaded onto the free end of the screw. Rotation of the wingnut in one direction will enable the members 15 and 16 to move toward one another and decrease the spacing therebetween.

Following assembly of the clamp screw and nut with the other parts of the rod rest, the latter may be placed atop a support, such as the gunwale 34 of a boat, so that the shoulders 22 and 27 rest atop the gunwale. The wingnut 32 then may be adjusted to cause the clamp members to move toward one another and clamp the assembly on the gunwale. Since the clamp screw is located at a level between the body 1 and the gunwale 34 there is no interference by either of these parts with the adjustment of the clamp members.

The positioning of the rod rest on the gunwale should be such that the extension 8 extends upwardly and inwardly of the boat. In this position a rod R may have its butt end placed on the deck of the boat and be inclined upwardly so that an intermediate portion of the rod is accommodated in the notch 9 in the manner earlier described.

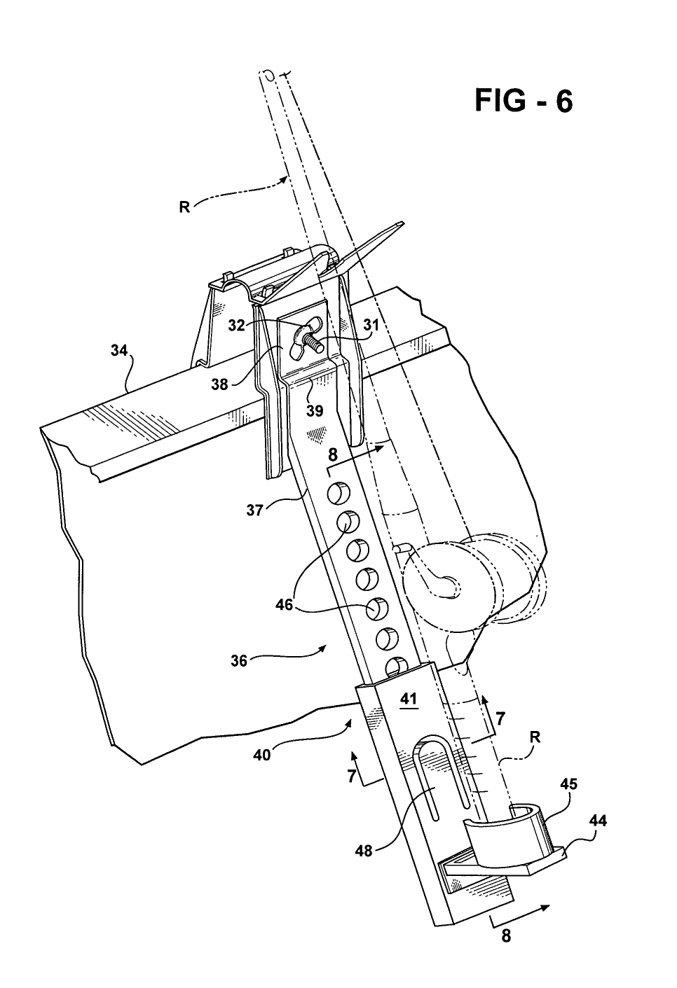

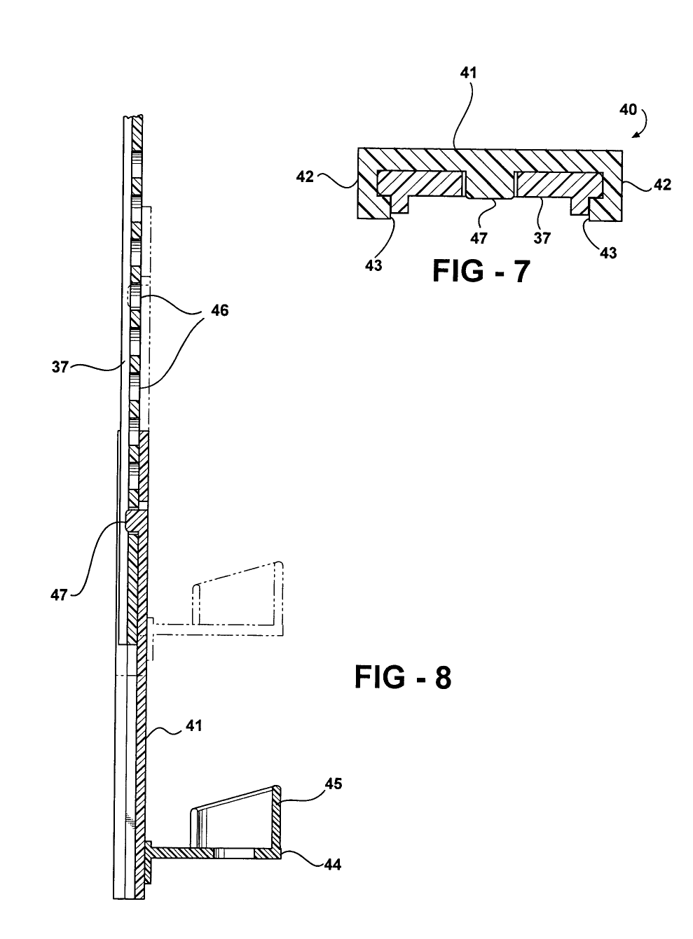

The embodiment shown in FIGS. 6-8 utilizes a clamp corresponding in all respects to the clamp 15. This embodiment also includes an extensible and retractable arm 36 having a first section 37 terminating at one end in a mounting flange 38 which may be placed against the portion 20 of the clamp member 16. The flange 38 has an opening therein for the accommodation of the clamp screw 31. The arm section 37 is restrained against rotation relative to the clamp 15 by the side rails 23. The mounting flange 38 terminates at its lower end in a step 39 which accommodates the shoulder 22 and then flares obliquely in a direction toward the deck of the boat.

The arm section 37 is accommodated in a second, slideable arm section 40 comprising a wall 41 having sides 42 terminating in inwardly turned flanges 43 which are effective to retain the extension 37 while enabling the section 40 to slide relative to the section 37.

Adjacent its free end the slideable section 40 is provided with a flange 44 on which is supported a socket 45. The socket is of such size as freely to accommodate the butt end of the fishing rod R.

The arm section 37 is provided with a plurality of spaced apart openings 46 each of which is of such size as to accommodate a latch projection 47 which is provided on the underside of a flexible latch finger 48 forming an integral part of the slide 40. The finger 48 also is resilient and normally is self-biased to a position in which the projection 47 will enter any selected one of the openings 46 when the finger is released. The finger is manipulable by displacing the projection occupying an opening in a direction out of such opening.

In this embodiment the slide section 40 is adjustable longitudinally of the section 37 so as to enable the rod R to be positioned at an appropriate level with respect to the extension 8.

The arm 36 is used in those instances in which the distance between the gunwale 34 and the deck of the boat is greater than that which should be spanned by the fishing rod R. The use of the arm 36 thus enables the butt of the rod to be supported at a higher level than otherwise would be the case.

In each of the disclosed embodiments a rod may be supported in such manner as to preclude inadvertent movement of the fishing rod in a direction along a path extending side to side of the notched extension 8. Nevertheless, because of the provision and configuration of the notch 9 in the extension 8 the rod instantly may be removed from the rod rest in a direction transversely of such path whenever desired.

A particular advantage of the apparatus disclosed herein is that a fisherman may obtain and use the body 1 with or without the clamp 15. Another advantage is that, if the clamp 15 is used, it may be used with or without the adjustable arm 36. Thus, the fisherman need not acquire more parts than he desires.

The disclosed embodiments are representative of presently preferred forms of the invention, but are intended to be illustrative rather than definitive thereof. The invention is defined in the claims.

1-20. (canceled).

21. A rest for an elongate article comprising a body member having a base flanked by a pair of substantially coplanar flanges; an extension unitarily joined to and projecting beyond one of said flanges; said extension being configured for removably receiving said article and disabling unintentional movement of such article in each of two opposite directions relative to said extension but permitting unrestricted movement of such article relative to said extension in a direction transversely of said path, each of said flanges having at least one slot therein; and clamping means removably accommodated in the slots of said flanges for removably clamping said rest atop a support, said extension projecting from said one of said flanges in a direction away from such support.

22. The rest according to claim 21 wherein said support is arcuate and said body member has a concave base for confronting and seating on said support.

23. The rest according to claim 22 wherein said extension has a V-shaped notch therein in which said article removably may be accommodated.

24. The rest according to claim 21 wherein said clamping means comprises at least one flexible tie member of such length as to encircle said support and said base.

25. The rest according to claim 21 wherein said clamping means comprises a pair of clamp members coupled to said body member via said slots and extending therefrom in substantially parallel, spaced apart condition, the space between said clamp members being sufficient to accommodate said support between said clamp members.

26. The rest according to claim 25 including adjusting means reacting between said clamp members for adjusting the space therebetween.

27. The rest according to claim 26 including an arm, connecting means connecting said arm at one end thereof to one of said clamp members, and means at the opposite end of said arm for supporting one end of said elongate article.

28. The rest according to claim 27 wherein said connecting means includes said adjusting means.

29. The rest according to claim 27 wherein said arm is composed of multiple sections relatively extensible and retractable longitudinally of said arm, and latch means reacting between said sections for releasably latching said sections in any selected one of a number of adjusted positions.

30. The rest according to claim 29 wherein said latch means comprises a plurality of openings in one of said sections and a projection carried by an adjacent one of said sections for movement into and out of any selected one of said openings.

31. A rest for an elongate fishing rod comprising a body member; a pair of confronting clamp members spaced apart a distance to accommodate a support therebetween; a first extension unitarily joined to and projecting in one direction away from said body member and having a notch therein for removably accommodating an intermediate portion of said rod; means coupling said body member and said confronting clamp members for rocking movements relative to the body member; and adjusting means reacting between said clamp members for rocking said clamp members relative to said body member and varying the space between said clamp members.

32. The rest according to claim 31 including a second extension, connecting means connecting said second extension to one of said clamp members, said second extension extending in a direction away from said first extension, and means carried by said second extension for removably accommodating another portion of said rod.

33. The rest according to claim 32 wherein said body member has openings therein, said coupling means comprising projections carried by said clamp members and rockably accommodated in openings in said body.

34. The rest according to claim 32 wherein said second extension includes a plurality of relatively adjustable sections, and latch means for releasably maintaining said sections in any selected one of a number of adjusted positions.

35. The rest according to claim 32 wherein said means for removably accommodating another portion of said rod comprises a socket.

36. The rest according to claim 32 wherein said connecting means and said adjusting means are the same.

37. A fishing rod rest adapted to be clamped on a part of a boat comprising:
a body member having a base flanked by a pair of substantially coplanar flanges, each of which has at least one slot therein;
a pair of substantially parallel clamp members spaced from one another a distance to accommodate therebetween at least a portion of said part of said boat;
coupling means carried by each of said clamp members and extending through said slots for rockably coupling said clamp members to said body member with said body member bridging said clamp members;
a first extension unitarily joined to one of the flanges of said body member and projecting therefrom in a direction away from said body member;
said first extension having a notch therein of such size as removably to accommodate a portion of said rod; and
adjusting means spanning said clamp members and operable to adjust the space between said clamp members thereby enabling said clamp members to be clamped to and unclamped from said part of said boat.

38. The fishing rod rest according to claim 37 including a second extension, second coupling means coupling said second extension to one of said clamp members, said second extension extending in a direction away from said body member and generally opposite the direction in which said first extension projects from said body member, and means carried by said second extension for removably accommodating another portion of said rod.

39. The rest according to claim 38 wherein said second extension comprises a plurality of relatively adjustable sections, and releasable latch means for releasably maintaining said sections in a selected one of a number of adjusted positions.

40. The rest according to claim 38 wherein said adjusting means and said second coupling means are the same
